(19) United States
(12) Patent Application Publication
(10) Pub. No.: US 2026/0161777 A1
(43) Pub. Date: Jun. 11, 2026

(54) SECURE COMPUTER MOBILE APP DEVICE

(71) Applicant: Josh Stroburg, Marana, AZ (US)

(72) Inventor: Josh Stroburg, Marana, AZ (US)

(21) Appl. No.: 19/051,591

(22) Filed: Feb. 12, 2025

Related U.S. Application Data
(60) Provisional application No. 63/730,133, filed on Dec. 10, 2024.

(51) Int. Cl. G06F 21/55; G08B 21/22; H04W 4/021

(52) U.S. Cl. CPC G06F 21/554; G08B 21/22; H04W 4/022

(57) ABSTRACT

A secure computer mobile application device is disclosed, which is a software application that may be downloaded onto a mobile device and a computer. The application alerts the user when he or she is away from their computer desk and an unauthorized person is trying to access the computer. The application allows the computer owner to lock or disable their computer when away to enforce cybersecurity. When an application is installed on the handheld device, it should be able to link to the MAC address of the main PC/laptop. Once linked, the application on the mobile device will alert the user if they move away from the computer without locking it. Ranges between the PC/laptop and electronic device can be determined by the application user when the electronic device is alerted.

### CROSS-REFERENCE TO RELATED APPLICATION

The present application claims priority to, and the benefit of, U.S. Provisional Application No. 63/730,133, which was filed on Dec. 10, 2024, and is incorporated herein by reference in its entirety.

### FIELD OF THE INVENTION

The present invention relates generally to the field of secure computer mobile application devices. More specifically, the present invention relates to a software application for desktop computers, smartphones, laptops, and other devices that alert owners when an unauthorized individual is using their electronic device. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in secure computer mobile application devices. Generally, people may leave their home or business computers, unlocked while away from their desk. An unlocked computer may be at risk for privacy invasion. Intruders may turn on a PC and try to log in with credentials. Computers that are unmonitored may be hacked without the owner knowing.

Further, it may be needed to prevent small children or other family members from accessing a home computer. Computers left unattended can be accessed by small children and other family members, which may access unauthorized computer programs and cause damage.

Accordingly, there is a demand for an improved secure computer mobile application device that provides users with a software application for desktop computers, smartphones, laptops, and other devices that alerts owners when an unauthorized individual is using their electronic device. More particularly, there is a demand for a secure computer mobile application device that allows users to lock and disable their computer when away from their desk.

Therefore, there exists a long felt need in the art for a secure computer mobile application device that provides users with a software application for desktop computers, smartphones, laptops, and other devices that alerts owners when an unauthorized individual is using their electronic device. There is also a long felt need in the art for a secure computer mobile application device that sends an alert to the computer owner's smartphone when unauthorized access to their computer is gained. Further, there is a long felt need in the art for a secure computer mobile application device that allows users to lock and disable their computer when away from their desk. Moreover, there is a long felt need in the art for a device that improves cybersecurity and prevents passwords and other private information from being stolen. Further, there is a long felt need in the art for a secure computer mobile application device that can be programmed to alert a user after the user is outside a specific range. Finally, there is a long felt need in the art for a secure computer mobile application device that includes a camera option.

The subject matter disclosed and claimed herein, in one embodiment thereof, comprises a secure computer mobile application device. The device is a software application that may be downloaded onto a mobile device and a computer. The application alerts the user when he or she is away from their computer desk and an unauthorized person is trying to access the computer. The application allows the computer owner to lock or disable their computer when away to enforce cybersecurity. When an application is installed on the handheld device, it should be able to link to the MAC address of the main PC/laptop. Once linked, the application on the mobile device will alert the user if they move away from the computer without locking it. Ranges between the PC/laptop and electronic device can be determined by the application user when the electronic device is alerted. For example, a user sets a range of 30 feet, and the electronic device will be alerted if the user is outside a 30 ft radius.

The length of time can be determined by the application user. However, the timer does not start until the user is out of range. It would be possible to disable the timer, and a yellow alert will immediately generate when the user is out of range of the unsecured PC/laptop. An additional red alert will be sent if the user is out of range and an intruder executes keystrokes on the unlocked PC/laptop. A camera option can also be used for red alerts if the hardware is available on the PC/laptop. The camera option can possibly identify the individual making keystrokes.

In this manner, the secure computer mobile application device of the present invention accomplishes all of the forgoing objectives and provides users with a software application for electronic devices to prevent unauthorized individuals from using it. The device locks and disables computers when users are away from their desk. The device can include a camera option.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a secure computer mobile application device. The device is a software application that may be downloaded onto a smart device and a desktop computer. The application alerts the user when he or she is away from their computer desk and an unauthorized person is trying to access the computer. The application allows the computer owner to lock or disable their computer when away to enforce cybersecurity.

In one embodiment, the secure computer mobile application device utilizes a smart device, such as a smartphone, a smart tablet, or a smart watch, etc., or any other suitable smart device that has the required operating and memory parameters to support the software application of the present invention.

In one embodiment, the secure mobile application device acts to secure an electronic device from unauthorized users. The electronic device can be any suitable desktop computer or laptop, etc., or any other suitable electronic device that has the required operation and memory parameters to support the software application of the present invention.

In one embodiment, the software application is downloaded on both the smart device and the electronic device. Once downloaded, the software application on the smart device is able to link to the MAC address of the electronic device (i.e., desktop computer/laptop). Then, once linked, the software application will alert the user if they move away from the computer without locking it. The software application then allows the user to lock or disable the electronic device when away from it via the software application on the smart device, to enforce cybersecurity. Thus, the software application prevents unauthorized users from gaining access to the unattended electronic device and tampering or altering with any information, computer files, data, etc., found on the electronic device.

In one embodiment, the software application allows users to program the specific ranges between the electronic device and the smart device to determine when the smart device will alert a user of the unattended electronic device (i.e., desktop computer). Thus, the software application will alert a user when they are out-of-range of the electronic device. For example, if a user sets a range of 30 feet, the smart device will be alerted if the user goes outside a 30 foot radius.

In one embodiment, the software application allows users to program a specific time limit when a user is to be alerted after leaving their pre-set range from the electronic device. Thus, the length of time before an alert is sent can be determined by the application user. For example, a user can program not to be alerted until they are out of range for a specific amount of time (i.e., 5 minutes). However, the timer within the software application does not start until the user is out of range.

In one embodiment, it is possible to disable the timer. However, if the timer is disabled, then a yellow alert is immediately sent to the user via the software application when the user is out-of-range of the unsecured desktop computer.

In one embodiment, the software application will send an additional red alert if the user is out-of-range and an intruder or unauthorized user executes keystrokes on the unlocked desktop/laptop.

In one embodiment, the software application utilizes a camera option for red alerts, as well, if the hardware is available on the desktop/laptop. Specifically, the software application can access the camera of the desktop/laptop (if the desktop/laptop has a camera) and utilize it to identify the unauthorized user executing keystrokes on the unsecured desktop/laptop. Thus, the camera option can possibly identify the individual making keystrokes and alert a user of the individual's identity via the software application.

In one embodiment, the mobile or software application provides secure smart device app access by users for securing an unlocked and unattended desktop computer. In addition to these elements, the device of the present invention may also include: a web server and Cloud database of desktop computer information and data connectable to the smart device, including the MAC address, etc. Thus, the software application can be utilized to secure multiple electronic devices via a single smart device.

In one embodiment of the invention, the secure desktop computer software is maintained on a Microsoft Cloud server in a typical fashion, or other cloud server, such as the Adobe, Apple or Amazon cloud server, etc. A secure cloud server is used for the protection and security of the secure desktop computer identification and data stored on the cloud server. Thus, the secure desktop computer identification and data is sent to the cloud server and collected. Conveniently, the data is stored and managed with a data management software or program to manage the secure desktop computer identification and data, etc.

Typically, a cellular wireless data network embedded in the smart device and/or electronic device transmits both secure desktop computer identification and data to a user and/or cloud server. Such secure desktop computer identification and data can be processed by the user via a Cloud data management server.

In yet another embodiment, the secure computer mobile application device comprises a plurality of indicia.

In yet another embodiment, a method of securing an electronic device from unauthorized use using a mobile application is disclosed. The method includes the steps of providing a secure computer mobile application device comprising a software application or mobile application. The method also comprises downloading or installing the software/mobile application on a smart device. Further, the method comprises downloading or installing the software/mobile application on a desktop or other electronic device. The method comprises linking the MAC address of the desktop to the software/mobile application. The method also comprises moving away from the desktop during use without locking it. Finally, the method comprises alerting a user of an unauthorized user accessing the desktop.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters

refer to similar parts throughout the different views, and in which:

FIG. 1 illustrates a perspective view of one embodiment of the secure computer mobile application device of the present invention in accordance with the disclosed architecture;

FIG. 2 illustrates a perspective view of one embodiment of the secure computer mobile application device of the present invention showing the mobile application on the smart device communicating with the electronic device in accordance with the disclosed architecture;

FIG. 3 illustrates a perspective view of one embodiment of the secure computer mobile application device of the present invention showing a user receiving alerts in accordance with the disclosed architecture;

FIG. 4 illustrates a flowchart showing the method of securing an electronic device from unauthorized use using a mobile application in accordance with the disclosed architecture;

FIG. 5 is a schematic diagram illustrating one embodiment of the software application for securing an electronic device from unauthorized use of the present invention in accordance with the disclosed architecture; and

FIG. 6 illustrates an exemplary user device that is used for installing the software application for securing an electronic device from unauthorized use of the present invention for communication with a server system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a secure computer mobile application device that provides users with a software application for desktop computers, smartphones, laptops, and other devices that alerts owners when an unauthorized individual is using their electronic device. There is also a long felt need in the art for a secure computer mobile application device that sends an alert to the computer owner's smartphone when unauthorized access to their computer is gained. Further, there is a long felt need in the art for a secure computer mobile application device that allows users to lock and disable their computer when away from their desk. Moreover, there is a long felt need in the art for a device that improves cybersecurity and prevents passwords and other private information from being stolen. Further, there is a long felt need in the art for a secure computer mobile application device that can be programmed to alert a user after the user is outside a specific range. Finally, there is a long felt need in the art for a secure computer mobile application device that includes a camera option.

The present invention, in one exemplary embodiment, is a novel secure computer mobile application device. The device is a software application that may be downloaded onto a mobile device and a computer. The application alerts the user when he or she is away from their computer desk and an unauthorized person is trying to access the computer. The application allows the computer owner to lock or disable their computer when away to enforce cybersecurity. When an application is installed on the handheld device, it should be able to link to the MAC address of the main PC/laptop. Once linked, the application on the mobile device will alert the user if they move away from the computer without locking it. The present invention also includes a novel method of securing an electronic device from unauthorized use using a mobile application. The method includes the steps of providing a secure computer mobile application device comprising a software application or mobile application. The method also comprises downloading or installing the software/mobile application on a smart device. Further, the method comprises downloading or installing the software/mobile application on a desktop or other electronic device. The method comprises linking the MAC address of the desktop to the software/mobile application. The method also comprises moving away from the desktop during use without locking it. Finally, the method comprises alerting a user of an unauthorized user accessing the desktop.

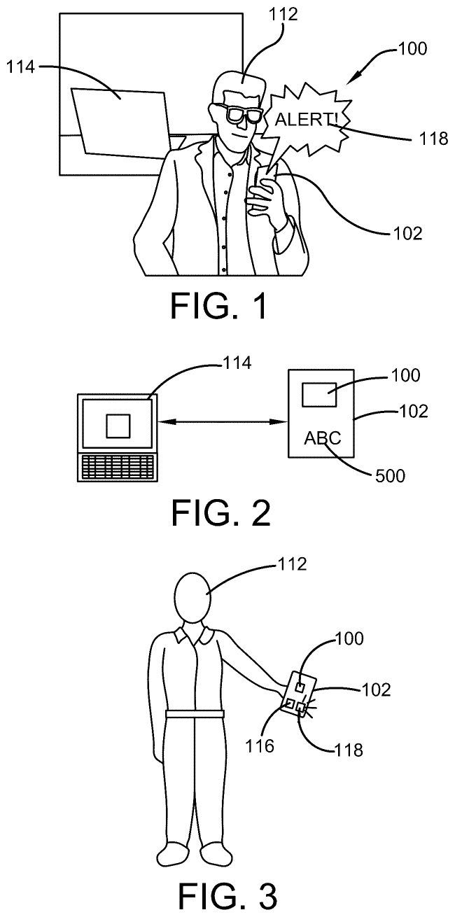

Referring initially to the drawings, FIG. 1 illustrates a perspective view of one embodiment of the secure computer mobile application device 100 of the present invention. In the present embodiment, the secure computer mobile application device 100 is an improved secure computer mobile application device 100 that provides a user 112 with a software application or mobile application that allows users 112 to secure a desktop or other electronic device 114 from unauthorized use. The device 100 is a mobile/software application that alerts users 112 when an unauthorized individual is using their electronic device 114. Specifically, the device 100 is a unique software application accessible on a smartphone, smart tablet, smart watch, etc., (i.e., smart device 102). The secure computer mobile application device 100 will allow a user 112 to lock or disable their computer 114 when away to enforce cybersecurity.

Further, the secure computer mobile application device 100 utilizes a smart device 102, such as a smartphone, a smart tablet, or a smart watch, etc., or any other suitable smart device 102 that has the required operating and memory parameters to support the software application of the present invention.

Additionally, the secure mobile application device 100 acts to secure an electronic device 114 from unauthorized users. The electronic device 114 can be any suitable desktop computer or laptop, etc., or any other suitable electronic device 114 that has the required operation and memory parameters to support the software application of the present invention.

As shown in FIG. 2, the software application is downloaded on both the smart device 102 and the electronic device 114. Once downloaded, the software application on the smart device 102 is able to link to the MAC address of the electronic device 114 (i.e., desktop computer/laptop). Then, once linked, the software application will alert the user 112 if they move away from the computer 114 without locking it. The software application then allows the user 112 to lock or disable the electronic device 114 when away from it via the software application on the smart device 102, to enforce cybersecurity. Thus, the software application prevents unauthorized users from gaining access to the unattended electronic device 114 and tampering or altering with any information, computer files, data, etc., found on the electronic device 114.

Further, the software application allows users 112 to program the specific ranges between the electronic device 114 and the smart device 102 to determine when the smart device 102 will alert a user 112 of the unattended electronic device 114 (i.e., desktop computer). Thus, the software application will alert a user 112 when they are out-of-range of the electronic device 114. For example, if a user 112 sets a range of 30 feet, the smart device 102 will be alerted if the user 112 goes outside a 30 foot radius.

Additionally, the software application allows users 112 to program a specific time limit when a user 112 is to be alerted after leaving their pre-set range from the electronic device 114. Thus, the length of time before an alert 118 is sent can be determined by the application user. For example, a user 112 can program not to be alerted until they are out of range for a specific amount of time (i.e., 5 minutes). However, the timer 116 within the software application does not start until the user 112 is out of range.

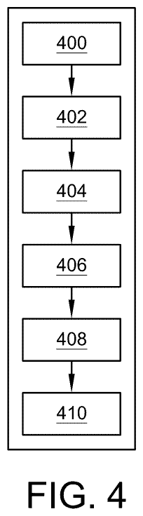

As shown in FIG. 3, it is possible to disable the timer 116. However, if the timer 116 is disabled, then a yellow alert 118 is immediately sent to the user 112 via the software application when the user 112 is out-of-range of the unsecured desktop computer 114.

Further, the software application will send an additional red alert 118 if the user 112 is out-of-range and an intruder or unauthorized user executes keystrokes on the unlocked desktop/laptop 114.

Additionally, the software application utilizes a camera option 120 for red alerts 118, as well, if the hardware is available on the desktop/laptop 114. Specifically, the software application can access the camera 120 of the desktop/laptop 114 (if the desktop/laptop has a camera) and utilize it to identify the unauthorized user executing keystrokes on the unsecured desktop/laptop 114. Thus, the camera option can possibly identify the individual making keystrokes and alert a user 112 of the individual's identity via the software application.

Generally, the mobile or software application provides secure smart device app access by users 112 for securing an unlocked and unattended desktop computer 114. In addition to these elements, the device 100 of the present invention may also include: a web server 108 and Cloud database 110 of desktop computer 114 information and data connectable to the smart device 102, including the MAC address, etc. Thus, the software application can be utilized to secure multiple electronic devices 114 via a single smart device 102.

Further, the secure desktop computer software is maintained on a Microsoft Cloud server in a typical fashion, or other cloud server, such as the Adobe, Apple or Amazon cloud server, etc. A secure cloud server is used for the protection and security of the secure desktop computer identification and data stored on the cloud server. Thus, the secure desktop computer identification and data is sent to the cloud server and collected. Conveniently, the data is stored and managed with a data management software or program to manage the secure desktop computer identification and data, etc.

Typically, a cellular wireless data network 106 embedded in the smart device 102 and/or electronic device transmits both secure desktop computer identification and data to a user and/or cloud server. Such secure desktop computer identification and data can be processed by the user via a Cloud data management server.

In yet another embodiment, the secure computer mobile application device 100 comprises a plurality of indicia 500. Specifically, the software application of the device 100 may include advertising, a trademark, or other letters, designs, or characters, printed, painted, stamped, or integrated into the software application, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be computer, desktop, or brand related.

FIG. 4 illustrates a flowchart of the method of securing an electronic device from unauthorized use using a mobile application. The method includes the steps of at 400, providing a secure computer mobile application device comprising a software application or mobile application. The method also comprises at 402, downloading or installing the software/mobile application on a smart device. Further, the method comprises at 404, downloading or installing the software/mobile application on a desktop or other electronic device. The method comprises at 406, linking the MAC address of the desktop to the software/mobile application. The method also comprises at 408, moving away from the desktop during use without locking it. Finally, the method comprises at 410, alerting a user of an unauthorized user accessing the desktop.

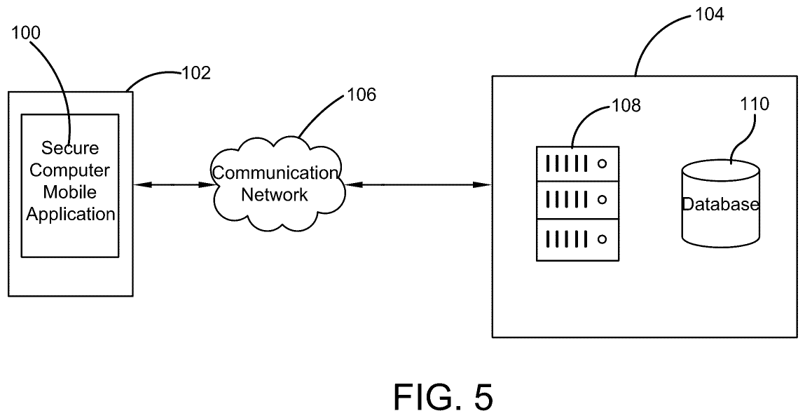

FIG. 5 is a schematic diagram illustrating one embodiment of the software application for securing a computer/desktop 100 of the present invention. The application 100 has a client-server architecture wherein a user accesses the application 100 installed on a user device 102. The application 100 also comprises a server system 104 and the user device 102 is communicatively coupled to the server system 104 via a communication network 106, such as the Internet. The user device 102 is capable of facilitating a user to input data, receive data, and/or transmit data within the application 100. It will be apparent to a user of ordinary skill in the art that the user may be any personnel using the application 100, without deviating from the scope of the disclosure. Examples of the user device 102 may include, but are not limited to, a desktop, a notebook, a laptop, a handheld computer, a touch sensitive device, a tablet, a computing device, a smart-phone, and/or a smart watch, etc., or any other suitable device as is known in the art.

The server system 104 is a network of computers, a software framework, or a combination thereof, that may provide a generalized approach to creating the server implementation. More specifically, the server system 104 includes an application server 108 and one or more associated databases 110. The application server 108 and the databases 110 can be integrated as a single unit or can be coupled to each other through a network. Examples of the application server 108 may include, but are not limited to, personal computers, laptops, mini-computers, mainframe computers, any non-transient and tangible machine that can execute a machine-readable code, cloud-based servers, distributed server networks, or a network of computer systems, etc. The application server 108 can be realized through various web-based technologies such as, but not limited to, a Java web-framework, a . NET framework, a personal home page (PHP) framework, or any web-application framework, etc. The server system 104 can be maintained by a storage facility management authority or a third-party entity that facilitates service enablement and resource allocation operations of the application 100.

The application server 108 is configured to have the logic, instructions, circuitry, interfaces, and/or codes for executing various operations required for communication between the server 108 and the user device 102 and also between the databases 110 and the server 108. The databases 110 are configured to store therein, data associated with the desktop computer or other electronic device that is being secured from the application 100. In some embodiments, a set of centralized or distributed network of peripheral memory devices may be interfaced with the server 104, as an example, on a cloud server.

The communication network 106 may include suitable logic, circuitry, and interfaces that may be configured to provide a plurality of network ports and a plurality of communication channels for transmission and reception of data related to operations of various entities (such as the user device 102 and the server system 104) of the application 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 106 may be associated with an application layer for implementation of communication protocols based on one or more communication requests from the user device 102 and the server system 104. The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel or a plurality of communication channels in the communication network 106. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

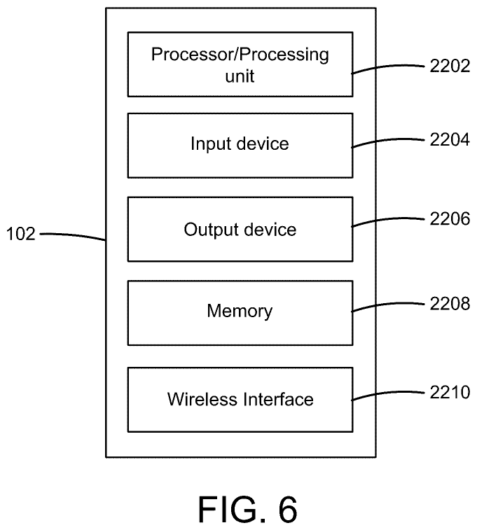

FIG. 6 illustrates an exemplary user device 102 that is used for installing the software application 100 of the present invention. The processing unit 2202 may include suitable logic, instructions, circuitry, interfaces, and/or codes for executing various operations, such as the operations associated with the user device 102, etc. The processing unit 2202 may be configured to control one or more operations executed by the user device 102 in response to the input received at the user device 102 from the user. The processor 2202 executes the computer readable instructions stored in the software application. Examples of the processing unit 2202 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), etc. Embodiments of the present disclosure are intended to include or otherwise cover any type of processing unit 2202 including known, related art, and/or later developed processing units. The user device 102 can further include one or more computer executable applications configured to be executed by the processing unit 2202. The one or more computer executable applications may include suitable logic, instructions, and/or codes for executing various operations. The one or more computer executable applications may be stored in the memory 2208. The one or more computer executable applications includes the software application 100.

The user device 102 comprises input device(s) 2204, such as a touch input device, a voice input device, etc., for entering data and information. Preferably, the touch interface of the user device 102 is used as the input and various buttons/tabs shown on the software application are pressed or clicked by the user.

Electronic device 102 also comprises a memory 2208 used for storing programs (sequences of instructions) or data (i.e., program state information) on a temporary or permanent basis for use in the computer system. Memory 2208 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 2202, in combination with one or more of memory 2208, input device(s) 2204, and output device(s) 2206 is utilized to allow users to execute instructions on the application 100. The connection to a network is provided by wireless interface 2210.

The wireless interface 2210 enables the user device 102 to communicate with the server 104 and other components of the application 100 over the communication network 106, according to embodiments of the present disclosure. Examples of the communication interface 2210 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit, etc. It will be apparent to a user of ordinary skill in the art that the communication interface 2210 may include any device and/or apparatus capable of providing wireless or wired communications between the user device 102 and the server 104.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “secure computer mobile application device”, “mobile application device”, and “device” are interchangeable and refer to the secure computer mobile application device 100 of the present invention.

Notwithstanding the forgoing, the secure computer mobile application device 100 of the present invention can be of any suitable size and configuration as is known in the art without affecting the overall concept of the invention, provided that it accomplishes the above stated objectives. One of ordinary skill in the art will appreciate that the secure computer mobile application device 100 as shown in FIGS. 1-6 is for illustrative purposes only, and that many other sizes and shapes of the secure computer mobile application device 100 are well within the scope of the present disclosure. Although the dimensions of the secure computer mobile application device 100 are important design parameters for user convenience, the secure computer mobile application device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A secure computer mobile application device that allows users to secure a desktop from unauthorized use, the secure computer mobile application device comprising:
a software application;
wherein the software application is accessible on a smart device; and
further wherein the software application is in communication with an electronic device and alerts users when an unauthorized individual is using the electronic device.

2. The secure computer mobile application device of claim 1, wherein the smart device is a smartphone, tablet, laptop, or a desktop computer.

3. The secure computer mobile application device of claim 2, wherein the electronic device can be any suitable desktop computer or laptop.

4. The secure computer mobile application device of claim 3, wherein the software application is downloaded on both the smart device and the electronic device.

5. The secure computer mobile application device of claim 4, wherein once downloaded, the software application on the smart device is able to link to a MAC address of the electronic device.

6. The secure computer mobile application device of claim 5, wherein once linked, the software application will alert the user if the user moves away from the electronic device without locking it.

7. The secure computer mobile application device of claim 6, wherein the software application then allows the user to lock or disable the electronic device when away from it via the software application on the smart device.

8. The secure computer mobile application device of claim 7, wherein the software application allows users to program specific ranges between the electronic device and the smart device to determine when the smart device will alert a user of the unattended electronic device.

9. The secure computer mobile application device of claim 8, wherein a user sets a range of 30 feet, the smart device will be alerted if the user goes outside a 30 foot radius.

10. The secure computer mobile application device of claim 9, wherein the software application allows users to program a specific time limit when a user is to be alerted after leaving their pre-set range from the electronic device.

11. The secure computer mobile application device of claim 10, wherein if a timer is disabled, then a yellow alert is immediately sent to the user via the software application when the user is out-of-range of the unsecured electronic device.

12. The secure computer mobile application device of claim 11, wherein the software application will send an additional red alert if the user is out-of-range and an intruder or unauthorized user executes keystrokes on the unlocked electronic device.

13. The secure computer mobile application device of claim 12, wherein the software application utilizes a camera option for red alerts, to identify the unauthorized user executing keystrokes on the unsecured electronic device.

14. A secure computer mobile application device that allows users to secure a desktop from unauthorized use, the secure computer mobile application device comprising:
a software application;
wherein the software application is accessible on a smart device;
wherein the software application is downloaded on both the smart device and an electronic device;
wherein once downloaded, the software application on the smart device is able to link to a MAC address of the electronic device;
wherein once linked, the software application will alert the user if the user moves away from the electronic device without locking it;
wherein the software application allows users to program specific ranges between the electronic device and the smart device to determine when the smart device will alert a user of the unattended electronic device;
wherein the software application allows users to program a specific time limit when a user is to be alerted after leaving their pre-set range from the electronic device; and
further wherein the software application is in communication with the electronic device and alerts users when an unauthorized individual is using the electronic device.

15. The secure computer mobile application device of claim 14, wherein the smart device is a smartphone, tablet, laptop, or a desktop computer; and the electronic device is a desktop computer or laptop.

16. The secure computer mobile application device of claim 14, wherein if a timer is disabled, then a yellow alert is immediately sent to the user via the software application when the user is out-of-range of the unsecured electronic device.

17. The secure computer mobile application device of claim 16, wherein the software application will send an additional red alert if the user is out-of-range and an intruder or unauthorized user executes keystrokes on the unlocked electronic device.

18. The secure computer mobile application device of claim 17, wherein the software application utilizes a camera option for red alerts, to identify the unauthorized user executing keystrokes on the unsecured electronic device.

19. The secure computer mobile application device of claim 14 further comprising a plurality of indicia.

20. A method of securing an electronic device from unauthorized use using a mobile application, the method comprising the following steps:
providing a secure computer mobile application device comprising a software application or mobile application;
downloading or installing the software/mobile application on a smart device;
downloading or installing the software/mobile application on a desktop or other electronic device;
linking the MAC address of the desktop to the software/mobile application;
moving away from the desktop during use without locking it; and
alerting a user of an unauthorized user accessing the desktop.
